(19) United States
(12) Patent Application Publication
(10) Pub. No.: US 2026/0281126 A1
(43) Pub. Date: Sep. 17, 2026

(54) AUTONOMOUS IDENTIFICATION OF ELECTRICAL SIGNATURES WITH IOT-ENABLED MONITORS

(71) Applicant: Volta Insite (US) Inc., Cornelius, NC (US)

(72) Inventors: Karimulla Raja Shaikh, Cupertino, CA (US); Daniel Montbriand, Santa Cruz, CA (US); Alfred Xue, Mississauga (CA)

(73) Assignee: Volta Insite (US) Inc., Cornelius, NC (US)

(21) Appl. No.: 19/630,591

(22) Filed: Mar. 27, 2026

Related U.S. Application Data
(63) Continuation-in-part of application No. 19/565,654, filed on Mar. 13, 2026.
(60) Provisional application No. 63/771,714, filed on Mar. 14, 2025.
(60) Provisional application No. 63/779,393, filed on Mar. 28, 2025.
(60) Provisional application No. 63/787,764, filed on Apr. 12, 2025.
(60) Provisional application No. 63/814,170, filed on May 29, 2025.
(60) Provisional application No. 63/824,111, filed on Jun. 15, 2025.
(60) Provisional application No. 63/842,417, filed on Jul. 11, 2025.
(60) Provisional application No. 63/868,054, filed on Aug. 21, 2025.
(60) Provisional application No. 63/875,633, filed on Sep. 4, 2025.
(60) Provisional application No. 63/886,244, filed on Sep. 23, 2025.
(60) Provisional application No. 63/893,080, filed on Oct. 3, 2025.
(60) Provisional application No. 63/908,902, filed on Oct. 31, 2025.
(60) Provisional application No. 63/920,989, filed on Nov. 19, 2025.
(60) Provisional application No. 63/920,997, filed on Nov. 19, 2025.
(60) Provisional application No. 63/927,701, filed on Nov. 30, 2025.
(60) Provisional application No. 63/933,557, filed on Dec. 8, 2025.
(60) Provisional application No. 63/951,992, filed on Dec. 31, 2025.
(60) Provisional application No. 63/969,898, filed on Jan. 28, 2026.
(60) Provisional application No. 63/980,195, filed on Feb. 11, 2026.
(60) Provisional application No. 63/980,279, filed on Feb. 11, 2026.
(60) Provisional application No. 63/991,428, filed on Feb. 26, 2026.
(60) Provisional application No. 63/991,451, filed on Feb. 26, 2026.
(60) Provisional application No. 63/994,200, filed on Mar. 2, 2026.
(60) Provisional application No. 64/004,156, filed on Mar. 12, 2026.

(51) Int. Cl. H04L 9/40; G06N 3/042

(52) U.S. Cl. CPC H04L 63/1408; G06N 3/042

(57) ABSTRACT

An industrial IoT electrical monitor (IIEM) is accessed. The IIEM is coupled to one or more industrial devices within one or more environments. Electrical data associated with the one or more industrial devices is recorded by the IIEM. The recording is based on a sampling frequency. One or more anomalous events associated with an industrial device within the one or more industrial devices are identified by a language model. The identifying is based on the electrical data that was recorded. The identifying is further based on contextual information. The one or more anomalous events that were identified are reported to a user. The one or more anomalous events are based on the electrical data that was recorded. The contextual information includes a plurality of historical events. Each historical event within the plurality of historical events is associated with one or more signatures.

### RELATED APPLICATIONS

This application claims the benefit of U.S. provisional patent applications “Autonomous Identification Of Electrical Signatures With IOT-Enabled Monitors” Ser. No. 63/779,393, filed Mar. 28, 2025, “Identification Of Electrical Signatures With Local Machine Learning Models On An IOT-Enabled Monitor” Ser. No. 63/787,764, filed Apr. 12, 2025, “Ground Fault Identification With IOT Enabled Monitors” Ser. No. 63/814,170, filed May 29, 2025, “Detection And Response To Frequency Deviations With IOT Enabled Monitors” Ser. No. 63/824,111, filed Jun. 15, 2025, “Frequency Deviation Detection And Response With IOT-Enabled Monitors” Ser. No. 63/842,417, filed Jul. 11, 2025, “Industrial Device Root Cause Analysis With Artificial Intelligence Agents” Ser. No. 63/868,054, filed Aug. 21, 2025, “Root Cause Analysis On Industrial Devices With Artificial Intelligence Agents” Ser. No. 63/875,633, filed Sep. 4, 2025, “Contactor Monitoring And Analysis With IOT-Enabled Monitors” Ser. No. 63/886,244, filed Sep. 23, 2025, “Variable Frequency Drive Isolation With IOT-Enabled Monitors” Ser. No. 63/893,080, filed Oct. 3, 2025, “Reconstruction Of Saturated Electrical Data With Industrial IOT Electrical Monitors” Ser. No. 63/908,902, filed Oct. 31, 2025, “Aggregated Analysis Of Electrical Signatures With Event Filters And Industrial IOT-Enabled Monitors” Ser. No. 63/920,989, filed Nov. 19, 2025, “Self-Regulating Industrial IOT-Enabled Monitors (IIEMS) With Event Filters” Ser. No. 63/920,997, filed Nov. 19, 2025, “Monitoring Variable Resolution Electrical Data With Industrial IOT Electrical Monitors” Ser. No. 63/927,701, filed Nov. 30, 2025, “Isolation For Electrical Analysis Of Industrial Equipment With Industrial IOT-Enabled Monitors” Ser. No. 63/933,557, filed Dec. 8, 2025, “Managing Anomalous Events Associated With Industrial Devices With An Applications Engineer Artificial Intelligence Agent” Ser. No. 63/951,992, filed Dec. 31, 2025, “Automatic Initialization Of Industrial IOT-Enabled Monitors” Ser. No. 63/969,898, filed Jan. 28, 2026, “Initializing Industrial IOT-Enabled Monitors With Zero Crossing Time Lags” Ser. No. 63/980,195, filed Feb. 11, 2026, “Residual Back EMF Analysis With Industrial IOT-Enabled Monitors Coupled To Industrial Devices” Ser. No. 63/980,279, filed Feb. 11, 2026, “Recognizing Anomalous Events With Frequency Transformations By IOT-Enabled Monitors” Ser. No. 63/991,428, filed Feb. 26, 2026, “Internal Temperature Tracking Of Industrial Devices With IOT-Enabled Monitors” Ser. No. 63/991,451, filed Feb. 26, 2026, “Auto Channel Mapping For IOT-Enabled Monitors Coupled To Industrial Devices” Ser. No. 63/994,200, filed Mar. 2, 2026, and “Root Cause Analysis Of An Anomalous Event With An Applications Engineer Artificial Intelligence Agent” Ser. No. 64/004,156, filed Mar. 12, 2026.

This application is also a continuation-in-part of U.S. patent application “Continuous Capture Of Electrical Signatures With IOT Enabled Monitors” Ser. No. 19/565,654, filed Mar. 13, 2026, which claims the benefit of U.S. provisional patent applications “Continuous Capture Of Electrical Signatures With IOT Enabled Monitors” Ser. No. 63/771,714, filed Mar. 14, 2025, “Autonomous Identification Of Electrical Signatures With IOT-Enabled Monitors” Ser. No. 63/779,393, filed Mar. 28, 2025, “Identification Of Electrical Signatures With Local Machine Learning Models On An IOT-Enabled Monitor” Ser. No. 63/787,764, filed Apr. 12, 2025, “Ground Fault Identification With IOT Enabled Monitors” Ser. No. 63/814,170, filed May 29, 2025, “Detection And Response To Frequency Deviations With IOT Enabled Monitors” Ser. No. 63/824,111, filed Jun. 15, 2025, “Frequency Deviation Detection And Response With IOT-Enabled Monitors” Ser. No. 63/842,417, filed Jul. 11, 2025, “Industrial Device Root Cause Analysis With Artificial Intelligence Agents” Ser. No. 63/868,054, filed Aug. 21, 2025, “Root Cause Analysis On Industrial Devices With Artificial Intelligence Agents” Ser. No. 63/875,633, filed Sep. 4, 2025, “Contactor Monitoring And Analysis With IOT-Enabled Monitors” Ser. No. 63/886,244, filed Sep. 23, 2025, “Variable Frequency Drive Isolation With IOT-Enabled Monitors” Ser. No. 63/893,080, filed Oct. 3, 2025, “Reconstruction Of Saturated Electrical Data With Industrial IOT Electrical Monitors” Ser. No. 63/908,902, filed Oct. 31, 2025, “Aggregated Analysis Of Electrical Signatures With Event Filters And Industrial IOT-Enabled Monitors” Ser. No. 63/920,989, filed Nov. 19, 2025, “Self-Regulating Industrial IOT-Enabled Monitors (IIEMS) With Event Filters” Ser. No. 63/920,997, filed Nov. 19, 2025, “Monitoring Variable Resolution Electrical Data With Industrial IOT Electrical Monitors” Ser. No. 63/927,701, filed Nov. 30, 2025, “Isolation For Electrical Analysis Of Industrial Equipment With Industrial IOT-Enabled Monitors” Ser. No. 63/933,557, filed Dec. 8, 2025, “Managing Anomalous Events Associated With Industrial Devices With An Applications Engineer Artificial Intelligence Agent” Ser. No. 63/951,992, filed Dec. 31, 2025, “Automatic Initialization Of Industrial IOT-Enabled Monitors” Ser. No. 63/969,898, filed Jan. 28, 2026, “Initializing Industrial IOT-Enabled Monitors With Zero Crossing Time Lags” Ser. No. 63/980,195, filed Feb. 11, 2026, “Residual Back EMF Analysis With Industrial IOT-Enabled Monitors Coupled To Industrial Devices” Ser. No. 63/980,279, filed Feb. 11, 2026, “Recognizing Anomalous Events With Frequency Transformations By IOT-Enabled Monitors” Ser. No. 63/991,428, filed Feb. 26, 2026, “Internal Temperature Tracking Of Industrial Devices With IOT-Enabled Monitors” Ser. No. 63/991,451, filed Feb. 26, 2026, and “Auto Channel Mapping For IOT-Enabled Monitors Coupled To Industrial Devices” Ser. No. 63/994,200, filed Mar. 2, 2026.

Each of the foregoing applications is hereby incorporated by reference in its entirety.

### FIELD OF ART

This application relates generally to equipment monitoring, and more particularly to autonomous identification of electrical signals with IoT-enabled monitors.

### BACKGROUND

Industrial equipment plays a vital role in supporting key infrastructure, ensuring the smooth operation of modern economies. For example, manufacturing plants rely on equipment such as CNC (Computer Numerical Control) machines, conveyor systems, and robotic arms to maintain high production efficiency. In the oil and gas sector, drilling rigs and separation systems help extract and process raw materials safely and effectively. Likewise, transportation networks depend on heavy-duty compressors, signaling systems, and electric charging stations to keep freight and passenger systems running reliably.

Industrial equipment is also a cornerstone of both manufacturing and distribution operations, driving efficiency and productivity. In distribution centers, automated conveyor systems, vertical lifts, and robotic sorters can streamline the movement of inventory, ensuring fast and accurate shipping and receiving. On the manufacturing side, advanced machinery such as robotic arms, industrial mixers, extruders, and laser cutters can help produce and package goods with high precision. Robotic arms can excel in tasks such as assembly, welding, and material handling, serving to boost production speed, improve accuracy, and reduce the need for manual labor. High-capacity ventilation systems are important for regulating air quality and temperature in industrial environments, while also helping to remove airborne contaminants like dust, fumes, or excess heat. Industrial ovens, kilns, and curing chambers support processes ranging from food preparation to ceramics, metal heat treatment to pharmaceutical production. CNC machines capable of cutting, milling, and engraving a variety of materials enable manufacturers to achieve precise, repeatable designs. Additionally, separators and centrifuges play an essential role in industries such as chemical production and wastewater treatment by efficiently separating liquids and solids. Automated packaging equipment, including form-fill-seal machines, cappers, and shrink-wrapping systems, enhances production speed, maintains hygiene, and ensures consistent product presentation, making it indispensable across food, beverage, and consumer goods industries.

Moreover, data centers are also a vital part of modern infrastructure, supporting industries, driving innovation, and enabling global commerce. Sectors such as manufacturing, transportation, retail, and financial services all depend on data centers to ensure seamless operations and scalability. Companies utilize data centers for cloud-based services, artificial intelligence, and data analytics to optimize performance and improve decision-making. E-commerce platforms, financial institutions, and digital entertainment services rely on fast, secure data processing to deliver real-time experiences. Additionally, public services such as healthcare systems, emergency responders, and government agencies depend on data centers to store sensitive information securely and ensure uninterrupted access to critical systems. Behind the scenes, servers, networking equipment, power management systems, and specialized cooling infrastructure all work together to maintain reliability, performance, and data security, keeping these essential services running smoothly.

Industrial equipment plays a vital role in keeping the economy running, allowing businesses to produce goods and services more quickly, safely, and accurately. Industrial equipment also supports companies in scaling production, cutting expenses, and upholding consistent quality standards. In fact, modern society relies heavily on industrial equipment. Without reliable operation of industrial equipment, the world as we know it would be drastically different.

### SUMMARY

Industrial equipment failures can cause significant disruptions to both production and supply chains. When a key machine breaks down, entire production lines may stop, leading to delays in output and missed delivery targets. This can be especially costly in sectors like food processing or chemical production, where perishable or sensitive materials may spoil or become unusable. Downtime often translates to lost revenue, and companies may struggle to meet customer demands. Beyond the immediate impact, equipment failures can ripple through the supply chain, causing shortages of critical products and affecting other businesses that rely on timely shipments. In more severe cases, extended downtime can harm a company's reputation, lead to broken contracts, and even create safety risks. To mitigate these potential losses, disclosed implementations can enable IoT-based monitoring systems to detect issues early and maintain smooth operations.

Disclosed implementations provide techniques for equipment monitoring. An industrial IoT electrical monitor (IIEM) is accessed. The IIEM is coupled to one or more industrial devices within one or more environments. The IIEM records electrical data associated with one or more industrial devices within each environment. The recording of data can be based on a sampling frequency. A language model is used to identify one or more anomalous events associated with an industrial device within the one or more industrial devices. The identifying is based on the electrical data that was recorded, and the identifying is further based on contextual information. The one or more anomalous events that were identified are reported to a user based on the electrical data that was recorded.

A computer-implemented method for analysis is disclosed comprising: accessing an industrial IoT electrical monitor (IIEM), wherein the IIEM is coupled to one or more industrial devices within one or more environments; recording, by the IIEM, electrical data associated with the one or more industrial devices, wherein the recording is based on a sampling frequency; identifying, by a language model, one or more anomalous events associated with an industrial device within the one or more industrial devices, wherein the identifying is based on the electrical data that was recorded, and wherein the identifying is further based on contextual information; and reporting, to a user, the one or more anomalous events that were identified, wherein the one or more anomalous events are based on the electrical data that was recorded. In embodiments, the contextual information includes a plurality of historical events. Some embodiments comprise associating each historical event within the plurality of historical events with one or more signatures. In embodiments, the one or more signatures include a current imbalance. In embodiments, the one or more signatures include a voltage imbalance.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for autonomous identification of electrical signatures with IoT-enabled monitors.

FIG. 2 is a flow diagram for handling electrical data.

FIG. 3 is an infographic for IoT environments.

FIG. 4 is a block diagram for interpreting electrical data.

FIG. 5 is a block diagram for developing contextual information.

FIG. 6 is a block diagram for refining a language model based on updated contextual information.

FIG. 7 is an example of a voltage transient.

FIG. 8 is an example of a phase drop.

FIG. 9 is an example of an industrial equipment anomaly dashboard for autonomous identification of electrical signatures with IoT-enabled monitors.

FIG. 10 is a system diagram for autonomous interpretation of electrical signatures with IoT-enabled monitors.

### DETAILED DESCRIPTION

Industrial equipment is the backbone of the global economy. From generating power and enabling transportation to providing refrigeration, maintenance, and data services, nearly every sector depends on these machines. Production can be disrupted when equipment breaks down unexpectedly or operates intermittently, cutting into profits. Predicting such failures, however, is a complex challenge. Industrial machines are composed of numerous interconnected parts, such as fans, belts, gears, blowers, arms, chillers, and more. Any of these components can fail, leading to costly downtime.

Beyond mechanical wear and tear, harsh industrial environments such as manufacturing plants, food processing facilities, and data centers can introduce additional risks. Electrical transients, for example, can damage sensitive components, while fluctuations in voltage, current, temperature, vibration, and humidity can shorten equipment lifespan or cause sudden malfunctions. Because of these unpredictable factors, organizations often rely on scheduled maintenance checks to inspect and test equipment. However, these maintenance intervals tend to err on the side of caution, sacrificing production time to avoid breakdowns. Even with conservative scheduling, environmental factors can still trigger unexpected failures, making it clear that traditional maintenance strategies alone may not be enough to ensure consistent uptime.

Disclosed implementations provide an Industrial Internet of Things (IoT) Electrical Monitor (IIEM) that offers transformative advantages for modern industrial operations by providing intelligent, data-driven insights into machine performance and health. By continuously collecting electrical data, such as current, voltage, and power usage, from multiple industrial machines, the IIEM can create a real-time, comprehensive view of an entire facility's equipment. This constant monitoring can enable early detection of anomalous electrical patterns, which are then analyzed by a trained language model. Unlike traditional monitoring systems that only flag deviations, this enhanced setup interprets the data to determine likely causes behind the anomalies. For instance, a sudden drop in motor current might indicate a broken belt, dramatically reducing the motor's load. The language model can recognize this specific electrical signature and infer that the issue stems from a mechanical failure, rather than a false alarm or an unrelated electrical fluctuation. Accurate recognition of electrical signatures can increase uptime, increase equipment lifespan, reduce maintenance costs, and increase profits.

Another important benefit of disclosed implementations is the ability to accelerate troubleshooting and maintenance. By not only detecting irregularities but also identifying their probable causes, the IIEM allows support personnel to respond more quickly and effectively. Instead of spending valuable time diagnosing the problem from scratch, technicians receive an intelligent analysis that guides them toward the root cause, enabling faster repairs or part replacements. This reduction in diagnostic time can further minimize equipment downtime, keeping production lines moving and improving overall facility productivity. Additionally, the data gathered over time can contribute to future predictive maintenance strategies, helping to forecast potential failures before they occur, reducing unplanned outages, cutting operational costs, and extending the lifespan of critical machinery. The IIEM, paired with a language model, represents a leap forward from reactive maintenance to proactive, intelligent industrial management.

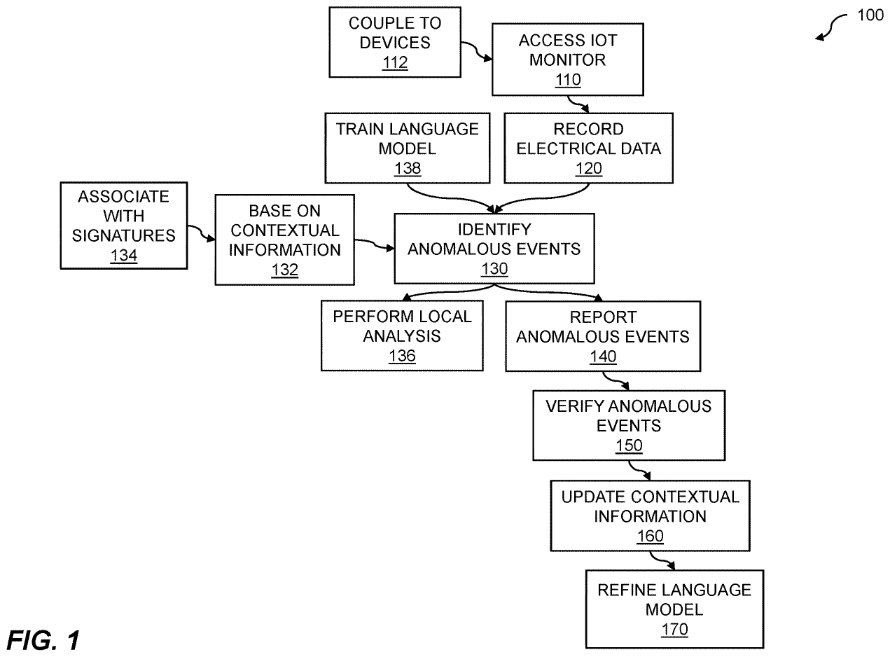

FIG. 1 is a flow diagram for autonomous identification of electrical signatures with IoT-enabled monitors. The flow 100 includes accessing an industrial IoT electrical monitor (IIEM) 110, wherein the IIEM is coupled to one or more industrial devices 112 within one or more environments. In disclosed implementations, the IIEM can include a single board computer (SBC) such as a Raspberry Pi® device, Banana Pi® device, BeagleBone® device, NVIDIA Jetson Nano®, a custom-designed computing device, and so on. The industrial devices that are coupled can include a wide range of equipment such as fans, pumps, compressors, motors, refrigeration units, ovens, server racks, robotic equipment, and so on.

The IIEM can comprise an IoT node which can interconnect devices, sensors, and servers to collect and exchange information over the Internet. The IIEM can include one or more communication transceivers. The communication transceivers can be based on BLE (Bluetooth Low Energy); Wi-Fi; cellular communication protocols such as 4G, 5G, and LTE-M; and/or other suitable communication protocols. The transceivers can enable high-speed data transfer to cloud servers and/or local networks. Other communication transceivers can include LoRa (Long Range) and/or Zigbee communication receivers. In some cases, one or more IoT nodes may include an ethernet port, serial port, and/or other port that supports wired communication, instead of, or in addition to, the communication transceivers.

In some implementations, the IIEM can be distinct from an IoT node. In those cases, one or more IIEMs within an environment can be coupled to one or more industrial devices. The one or more IIEMs can send data to the IoT device which can coordinate sending and receiving data with a compute device such as a computer, server, cloud server, etc. The IoT device can include one or more processors, communications interfaces, and so on. The IIEM can communicate with the IoT node via Bluetooth, cellular communications, and so on. In some cases, one or more IoT nodes may include an ethernet port, serial port, and/or other port that supports wired communication.

The IIEM can include a power source. The power source can include a battery, such as a rechargeable battery. In disclosed implementations, the battery can include a lithium-ion battery, lithium-ion polymer battery, and/or other suitable type of battery. In some cases, one or more IIEMs may include PoE (power over ethernet) to enable providing both power and network connectivity via a single cable. Some IIEMs may include energy harvesting features, such as solar cells, vibration-based energy generation, and/or other renewable energy sources that can enable remote, self-sustaining IoT monitoring.

The IIEM can include one or more processors. The processors can include an ARM®-based processor, a MIPS®-based processor, a custom processor, application specific integrated circuits (ASICs), systems-on-chip (SoCs), one or more embedded controllers, and/or another suitable processor type. The processors can serve to read sensor data, process interrupts, perform communication tasks, and/or execute other processes to accomplish IoT-based industrial device monitoring. The processor(s) can interface with an input/output (I/O) module. The I/O module can include analog inputs to enable reading signals from analog sensors such as temperature probes, current meters, voltage meters, and so on. The I/O module can include one or more analog-to-digital converters (ADCs) to convert analog signal levels into digital values. The I/O module can include digital inputs and outputs, such as GPIO (General Purpose I/O), in order to interface with other types of sensors such as tilt sensors, gyroscopes, accelerometers, and/or other types of sensors that provide digital outputs. Additionally, the I/O module can interface with an output device, such as an LED, buzzer, or other suitable output device. The I/O module can interface to a wide variety of sensors. The sensors can include temperature and humidity sensors to monitor environmental conditions. The sensors can include vibration sensors, which can be used to detect mechanical wear and/or anomalies in industrial equipment. The sensors can include current sensors and voltage sensors, which can measure power consumption and/or detect electrical issues. Other types of sensors can be used in disclosed implementations.

The IIEM can include computer storage, such as flash memory, for storing firmware images, configuration settings, sensor logs, waveforms, and so on. Additionally, some IIEMs can include an external storage interface, such as a microSD card slot, to enable local retrieval of collected data and/or logs. The computer storage can also include random-access memory (RAM) for supporting program execution and in some cases, analysis and/or processing of collected data.

The IIEM can be coupled to the one or more industrial devices via a network connection. The network connection can be a wireless connection, such as via BLE, Wi-Fi, or some other suitable connection. The network connection can be a wired connection, such as an ethernet connection, serial connection (e.g., RS-232, RS-485, or the like), and/or other type of wired connection. The coupling can include access, by the IIEM, to internal nodes of the industrial equipment to monitor internal conditions. The coupling can include access to current and/or voltage entering or exiting the industrial device. The one or more industrial devices can include robotic arms, CNC machines, 3D printers, welding machines, injection molding machines, conveyor belts, packaging equipment, sorting machines, uninterruptible power supplies, generators, power transformers, industrial circuit breakers, power distribution units, industrial HVAC systems, furnaces, boilers, refrigeration units, dehumidifiers and humidifiers, pumps, compressors, mixing tanks, water treatment systems, data center computer servers, network switches, routers, and/or other types of industrial devices. Any type of equipment that requires electricity can be monitored by the IIEM.

A single IIEM can be coupled to a single device or multiple devices, providing efficient IoT monitoring. The equipment can be physically located in an environment. Any environment can be monitored by the IIEM. For example, the equipment can be a room within a food processing facility, a rack within a data center, a floor within a manufacturing facility, and so on. Any number of IIEMs can be coupled to any number of industrial devices in any number of environments. In a usage example, a single IIEM can be coupled to a bandsaw and a table saw within a wood shop.

The flow 100 includes recording, by the IIEM, electrical data 120 associated with the one or more industrial devices, wherein the recording is based on a sampling frequency. The one or more industrial devices can be operated with power such as AC power, three-phase power, DC power, etc. The IIEM can record electrical data associated with signals, phases, etc. affiliated with such power as is provided. The IIEM can monitor power anywhere along the path of delivery to the industrial device. For example, a utility can provide three-phase power to the industrial environment. The IIEM can monitor each phase of this power input. Before powering the industrial device, the power can run through another device such as a contactor, a variable frequency drive (VFD), etc. The IIEM can monitor power both at the input and output of the contactor, VFD, or any other equipment or node as it is delivered to the industrial device. The IIEM can further monitor power, such as each phase of the three-phase power, at the input of the industrial device. Further, in an industrial environment, it is common for equipment to be manipulated by controllers such as a programmable logic controller (PLC). The IIEM can additionally monitor inputs and outputs of these control devices and compare control states with power delivery. This comprehensive monitoring provides unique insights into power delivery, control signaling, anomalous events, domain knowledge, and so on that can be used to identify, debug, etc. electrical anomalies associated with the industrial devices.

The electrical data can include average current, current spikes, average voltage, voltage spikes, frequency fluctuations, phase loss, phase delays, power interruptions, voltage and/or current transients, voltage waveforms, current waveforms, and so on. The electrical data can include a power factor (PF) that measures how efficiently electrical power is being converted into useful work. A declining power factor can indicate inefficiencies, aging equipment, and/or potential motor failures. The electrical data can include total harmonic distortion (THD). Harmonic distortions in voltage or current can indicate issues such as improper loads or electrical interference. The electrical data can include voltage imbalance in a three-phase system, which can lead to overheating, inefficiencies, and/or motor damage. The electrical data can include current imbalance in a three-phase system, which can indicate unbalanced loads and/or faulty components. The electrical data can include neutral current monitoring, which can identify unexpected currents on a neutral wire. These currents can indicate grounding issues or unbalanced phase loads. Disclosed implementations may record other electrical data instead of, or in addition to, the aforementioned electrical data. Other data such as vibration data, humidity data, temperature data, and so on can be recorded. The recording can occur at a sampling frequency, which can be different from the uploading frequency. The sampling frequency can occur at a fast enough rate to monitor changes in voltage, current, etc. For example, the sampling frequency can be 20 kHz, 40 kHz, 1 MHz, or another appropriate sampling rate. The recording can include environmental data. In embodiments, the environmental data includes temperature data. In some embodiments, the environmental data includes vibration data. In other embodiments, the environmental data includes humidity data.

The IIEM can upload data that was recorded to a cloud server. A cloud server can include a server in a cloud service such as Amazon Web Services (AWS), a custom managed server, a local server (e.g., on-site server, computer, and so on), etc. The cloud server can include any number of physical servers within a rack, data center, network, and so on. The cloud server can include any type of processor, ASIC, SoC, AI accelerator, etc. The cloud server can host a language model, such as a large language model (LLM), a small language model (SLM), or another suitable machine learning model. The language model can run on special purpose hardware within the cloud server such as one or more artificial intelligence (AI) accelerators, ASICS, and so on. The machine learning model can run on a processor, a processor with enhanced AI capability, and so on. Discussed below, the language model can provide equipment insights, failure analysis, warnings, and so on based on the data collected and uploaded by the IIEM.

The flow 100 includes identifying, by a language model, one or more anomalous events 130 associated with an industrial device within the one or more industrial devices, wherein the identifying is based on the electrical data that was recorded, and wherein the identifying is further based on contextual information 132. As mentioned previously, a language model can run on the cloud server. The language model can perform any number of inferences on data uploaded from any number of IIEMs to identify any number of anomalous events. An anomalous event can refer to a failure, a difference from normal operation, and so on in a piece of equipment. Anomalous events can be reported to a user, a floor manager, maintenance personnel, etc. to investigate whether a part failed or experienced a partial failure, to protect against a future failure, to investigate a non-normal operation, etc. The anomalous event can be associated with a signature within the operational data that was collected by the IIEM. The signature can include electrical data such as voltage and current behavior; environmental data such as vibration, humidity, airflow, or temperature data; data locally analyzed by the IIEM such as an FFT; and so on. The electrical signature can be correlated to an anomalous event by the LLM and applied to one or more pieces of equipment.

Examples of anomalous events are legion. For example, motor aging or increased mechanical resistance may be indicated by unusually high or prolonged current spikes. An anomalous event can include equipment overheating or loss of efficiency which may be indicated by harmonic distortions above a threshold. An anomalous event can include a different, or heavier, material being mixed within a mixer which may be indicated by a change in current load. An anomalous event can include an unplanned equipment shutdown which can be indicated by an unexpected load drop or decrease in power consumption. An anomalous event can include improper grounding issues which may be indicated by a rise in neutral current. Similarly, a broken drive belt on a motor may be indicated by a sudden, sharp increase in current followed by a drop in load in the electrical data uploaded by the IIEM. When the belt breaks, the motor can spin freely without the load, drawing less power afterward. In another example, a worn-out bearing in a fan or pump causing mechanical resistance may be indicated by a fluctuating voltage combined with a prolonged high current draw. Another example anomalous event can include a motor speed controller failure which may be indicated by repeated oscillations in current draw, where the regulator fails to stabilize the RPMs of the motor. An anomalous event can include coil degradation and/or insulation breakdown in a motor which may be indicated by a slow, consistent rise in current draw without a corresponding load increase. A further example anomalous event can include loose wiring and/or failing relays which may be indicated by intermittent current drops.

Disclosed implementations can continuously compare data uploaded by any number of IIEMs against contextual information (explained below) to detect an anomalous event. The detection can locate a failure and/or intermittent failure, predict a future failure, recommend an inspection, and so on. Disclosed implementations can predict a likely cause and alert maintenance staff with a likely explanation, which can be much more helpful than a simple error code for quickly resolving the issue, reducing equipment downtime, and improving overall efficiency of an industrial facility. Identifying one or more anomalous events can be key to maintaining uptime of industrial equipment. For example, to protect and debug equipment, a user can be notified to react to an anomalous event by briefly taking a machine offline, examining sensitive parts for failure or signs of fatigue, scheduling a maintenance interval, increasing the IIEM uploading frequency to look for additional failure signatures, and so on.

The identification of anomalous events is based on contextual information 132. In embodiments, the contextual information includes a plurality of historical events. Examples of historical events can comprise a loose belt, a ground fault, a roller failure, a motor back feed, and so on. The historical events can be cataloged as failures, warnings, etc., and can be collected within an environment over time. Historical events can be collected from any number of environments.

Embodiments include associating each historical event within the plurality of historical events with one or more signatures 134. Recall that the IIEM collects electrical data on any number of industrial devices such as motors, pumps, fans, and ovens. Sensors can sample and capture data, such as current, voltage, and power consumption, and provide this information to the IIEM. The IIEM can search for any number of signatures. The signatures can be associated with historical events within the contextual information. The machine learning model can use the contextual information to make inferences on data sent by the IIEM to the cloud server. For example, a phase drop signature can be associated with an immediate or future motor failure. Thus, the machine learning model can predict which (if any) motors may fail, estimate a time to failure, estimate a reduced motor life, and so on based on a detected phase drop in the IIEM data. The detected phase drop can have similar or different electrical characteristics than the phase drop, included in the signatures, that was associated with one or more historical events. In embodiments, the one or more signatures include a current imbalance. In embodiments, the one or more signatures include a voltage imbalance. In embodiments, the one or more signatures include a rate of current change. In embodiments, the one or more signatures include a rate of voltage change. In embodiments, the one or more signatures include a harmonic frequency amplitude. Many other signatures can be included. In embodiments, the recording includes environmental data, wherein the one or more signatures include the environmental data. In some embodiments, the environmental data includes temperature data. In other embodiments, the environmental data includes vibration data. In embodiments, the environmental data includes humidity data.

In embodiments, the identifying is based on performing local analysis 136, by the IIEM, on the electrical data that was recorded, wherein the local analysis includes a fast Fourier transform (FFT). The IIEM can perform local analysis on the data collected. The local analysis can include signal filtering. The signal filtering can include low-pass filtering to remove high-frequency noise while preserving useful signal components. The signal filtering can include high-pass filtering such as filtering to reduce low-frequency drift of DC bias. The signal filtering can include band-pass filtering to isolate a specific frequency range, such as power system harmonics. The local analysis can include a fast Fourier transform (FFT). An FFT can convert a signal in the time domain to the frequency domain, where frequency components within a voltage or current waveform can be analyzed. This can be useful for evaluating harmonics which can indicate errors in the equipment monitored, the power supply, and so on. The local analysis can include other transforms such as a short-time Fourier transform (STFT), wavelet transform, and/or other frequency domain operations. The local analysis can include statistical analysis. The statistical analysis can include computation of mean, variance, skewness, and/or kurtosis, to characterize the distribution of signal fluctuations. The statistical analysis can include computation of histograms of amplitudes, which can be used to obtain information on how often certain voltage/current values occur. The statistical analysis can include computation of power spectral density (PSD), to measure how signal power is distributed over frequency components. The local analysis can include peak and event detection. The peak and event detection can include detection of voltage and/or current spikes, RMS (root mean square) calculations, zero-crossing rate, and/or other relevant calculations. By performing preprocessing at the edge, disclosed implementations can filter noise, extract important features, detect anomalies, and reduce data volume before sending data to the cloud. This can not only conserve bandwidth, but also improve real-time monitoring and diagnostics. The results of the local analysis can be uploaded to the cloud server with the electrical data and/or environmental data. The results of the local analysis can be included in the contextual information and can be associated with historical events to improve language model analysis.

As described above, the machine learning model, which can be a language model, can make inferences about data uploaded by the IIEM based on the contextual information. In embodiments, the language model is executed by the cloud server. Embodiments include training the language model 138, wherein the training is based on the contextual information. The training can include supervised learning. In disclosed implementations, labeled historical data that associates anomalous events with interpreted outcomes can be obtained and used for the training. The data sources for the training can include historical sensor data from industrial devices, such as currents, voltages, frequencies, and/or other electrical parameters. The sensor data can include environmental data such as ambient temperature, humidity, vibration, etc. The data sources can further include logs from the industrial machines that indicate failures and/or degraded modes of operation. Additionally, the data can include human annotations from maintenance staff, engineers, etc.

Data samples can include a parameter value or time series of values, such as voltage, current, temperature, etc. The data sample further can include a timestamp. The data sample further can include an anomaly descriptor. The descriptor can include an alphanumeric code corresponding to an anomaly such as “sharp current crop,” “voltage fluctuation,” and the like. Additionally, the data sample can include a failure classification label, such as “broken belt,” “seized bearing,” “overheating motor,” “failed relay,” and so on. One or more implementations may further include an “unknown” label that can be used as a catchall for previously unencountered failure modes. In subsequent training, events with an “unknown” label can be updated to a more descriptive failure classification, to enable adaptive learning of the language model. The format of the data can be in a comma separated value (CSV) format, JSON format, or another suitable format.

The model training can further include a validation phase. A portion of the labeled data can be used as validation data and input to the language model as a test to determine if the trained language model successfully identifies the problem indicated in the validation data. For example, given an electrical signature that is associated with a broken motor belt, a check can be made to determine if the language model successfully identifies that failure mode. The language model can also be assessed to determine if the language model mistakenly interprets a normal event as a failure, and/or misses a failure altogether. That is, the assessment can include checking the language model for a rate of false positives and/or false negatives.

The flow 100 includes reporting, to a user, the one or more anomalous events that were identified 140, wherein the one or more anomalous events are based on the electrical data that was recorded. The anomalous events, such as those described in detail above, can be sent to a user, system administrator, shop manager, maintenance technician, and so on. The reporting can be based on an email, text, alert, phone call, etc. The reporting can include a confidence level associated with the anomalous event. That is, since many different equipment situations and/or failures can occur under many different electrical and environmental conditions, it may not be possible to directly correlate the anomalous event with a known failure. The language model can generate a probability based on the contextual information to guide the urgency with which the event should be handled.

The flow 100 includes verifying the one or more anomalous events 150 that were identified. The verifying can include receiving confirmation from maintenance personnel, engineers, and/or other qualified stakeholders that the reported failure mode is correct. Reporting a failure mode as correct can reinforce the model training. Reporting a failure mode as incorrect can enable a feedback loop that allows for ongoing retraining of the language model. As an example, a slight voltage dip might not always be indicative of loose wiring or a relay failure. By receiving the feedback from personnel, the language model can learn distinctions, such as what degree of voltage fluctuation determines an actionable event.

The flow 100 further includes updating the contextual information 160, wherein the updating is based on the verifying. An anomalous event can be investigated. The event may have been a “false alarm,” a true failure, a warning that a failure could occur in the future, and so on. The results of the verifying can be included in the contextual information for future analysis by the language model. The updating can include updating previously “unknown” events into meaningful events. As an example, when a pump in an industrial device fails, which has never failed previously, a corresponding anomalous event (e.g., electrical fluctuation) may be recognized as unusual, but will not be associated with the pump failure, since this is the first time that failure is encountered. That is, this particular instance of the pump failure is a “zero-day failure.” Disclosed implementations enable updating the contextual information for zero-day failures to enable enhancing the capabilities of the language model.

The flow 100 can include refining the language model 170, wherein the refining is based on the contextual information that was updated. In some embodiments, the language model comprises a large language model (LLM). An LLM can be large, requiring many processors, AI accelerators, etc. to retrain the model. Thus, the retraining process can take considerable time and energy. Because of compute power limitations, it may not be feasible to fully retrain the LLM to take advantage of new data reflected in updated contextual information. In these cases, the LLM can be refined. In embodiments, the refining is based on parameter-efficient tuning. The parameter-efficient tuning can include adapter tuning, prefix tuning, Low-Rank adaptation (LoRA), and/or other suitable techniques. In other embodiments, the refining is based on retrieval-augmented generation (RAG). In disclosed implementations, the RAG can provide a framework that combines the strengths of large language models (LLMs) with external knowledge retrieval systems to enhance their performance on tasks that make use of up-to-date and/or domain-specific information. In disclosed implementations, the RAG can be configured to dynamically retrieve relevant information from external sources, such as databases, document repositories, and/or other sources, during inference. The retrieved data can be fed into the language model, which uses them as context to generate a response or perform a task. This augmentation allows the model to produce outputs that are both accurate and grounded in the retrieved knowledge, which can include one or more signatures and associated historical events. The refining can include anomaly clustering. As an example, if an unknown anomaly keeps recurring, the model can group similar patterns and suggest new failure modes if the unknown anomaly has some resemblance to prior failure events. The refining can include transfer learning. As an example, if a language model is well trained for analyzing motor data, that language model can be retrained on similar data for different types of equipment, such as pumps and/or fans, without requiring training from scratch for those other industrial devices with a completely untrained language model. In embodiments, the language model comprises a small language model (SLM). Some embodiments include training the SLM, wherein the training is based on the contextual information that was updated. One or more implementations may utilize knowledge distillation to train a small language model (SLM) from an LLM, where the SLM can achieve acceptable performance while being efficient enough to operate with considerably less compute power than the LLM.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

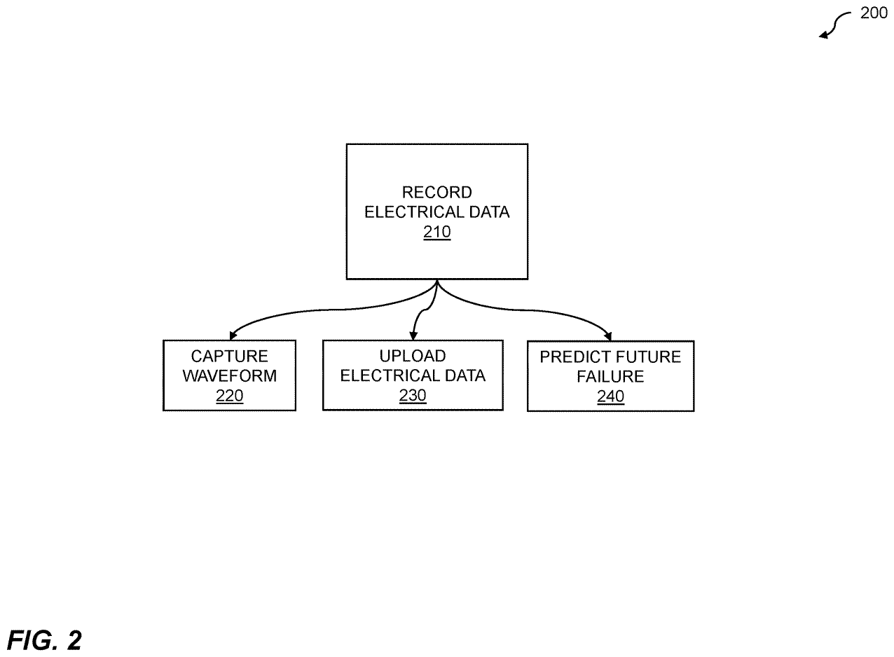

FIG. 2 is a flow diagram for handling electrical data. The flow 200 starts with recording electrical data 210. The electrical data can include current draw, voltage draw, power consumption, current spikes, voltage spikes, total harmonic distortion (THD), power factor (ratio of real power to apparent power), phase imbalance, frequency variations, apparent power (kVA), reactive power (kVAR), power cycle counts, and/or other parameters. These parameters can indicate potential problems with industrial equipment. As non-limiting examples, current spikes can signal motor stalls, short circuits, or startup stress; voltage fluctuations might point to power supply issues or poor wiring; and deviation from nominal power supply frequency (e.g., 50 Hz or 60 Hz) may indicate grid instability or generator issues.

The flow 200 includes capturing a waveform 220 of the electrical data associated with the one or more industrial devices. The waveform can include waveforms of electrical current and/or electrical voltage that are input to an environment, and/or one or more industrial devices within an environment. The waveform can comprise data that was sampled by the IIEM, summarized data, and the like. The waveform can span any timeframe. As described previously, the IIEM can perform local analysis which can include an FFT. The FFT can also be captured as a waveform by the IIEM, showing frequency components of the electrical signals that were captured. Other waveforms are possible from additional analysis procedures such as a short-time Fourier transform (STFT), wavelet transform, statistical analysis, and so on.

The flow 200 includes uploading, by the IIEM, to a cloud server, the electrical data 230 that was recorded, wherein the uploading is based on one or more uploading instructions. As described above and throughout, the electrical data can include voltage data, current data, power data, and so on. The electrical data can be uploaded to a cloud server. In addition to electrical data, environmental data, such as humidity, temperature, and/or vibration data, may also be uploaded. In embodiments, the uploading includes one or more portions of the electrical data surrounding an anomalous event.

The uploading can be based on uploading instructions received, by the IIEM, from the cloud server. The uploading instructions can control how and when the IIEM sends data once collected. The one or more uploading instructions can include an uploading frequency. The uploading can be based on the uploading frequency. A default upload frequency can be established, allowing the IIEM to upload data to the cloud server at a predefined frequency under normal operating conditions. The upload frequency can comprise any frequency such as ten times per hour, six times per minute, and so on. In a usage example, the uploading instructions can cause an IIEM coupled to a bandsaw to send summarized data to the cloud server in ten-minute increments. The uploading instructions can be heuristically developed. The instructions can be based on a historical database of equipment failures and/or electrical monitoring. A machine learning model, such as an LLM, neural network, transformer, and so on, can be used to determine appropriate instructions based on analysis of the historical database or other data. Thus, disclosed implementations can provide an industrial monitoring system that optimizes data transmission by dynamically adjusting the upload frequency based on real-time conditions.

The uploading can also be based on a situation of interest. The determining of the situation of interest, by the IIEM, can be based on received uploading instructions. A situation of interest can refer to an anomaly or event that may indicate a potential problem, future problem, unusual condition that warrants further investigation, and so on. The situation of interest can be related to power monitoring, frequent voltage fluctuations, current spikes, phase imbalance, harmonic distortions above a threshold, unexpected load drops, unusual neutral current behavior, a rapid temperature rise, humidity spikes, vibration amplitude above a threshold, and so on. Once the IIEM detects a situation of interest, it can upload information to the cloud server without having to wait for the next scheduled upload in the uploading frequency. Early identification of one or more situations of interest can be key to maintaining uptime of industrial equipment.

Recall that the IIEM records data based on a sampling frequency such as 20 kHz, 40 kHz, or another suitable frequency. Because the sampling frequency can be faster than the uploading frequency, the IIEM can be equipped to store data locally before sending it to a cloud server. When the uploading instructions direct an IIEM to upload electrical data associated with a situation of interest (which may correlate to an anomalous event such as those described above), the IIEM can send data prior to the situation of interest and/or after. This can be helpful in diagnosing failures and/or potential failures by including before-event and after-event signatures.

As explained above and throughout, the IIEM can send data to the cloud server for analysis by an LLM. The LLM can identify one or more anomalous events associated with an industrial device. In embodiments, the identifying includes predicting, by the language model, a future failure 240 of the one or more industrial devices. In disclosed implementations, the training data used to train the language model can teach the language model to identify future potential failures. The identified failures can be presented on a user interface to a user to alert the user to the issue. As an example, a user interface message can state: “Elevated current draw detected-potential motor overload. Service recommended within 3-5 days.” In this way, disclosed implementations can enable proactive, rather than reactive, maintenance within an industrial environment.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

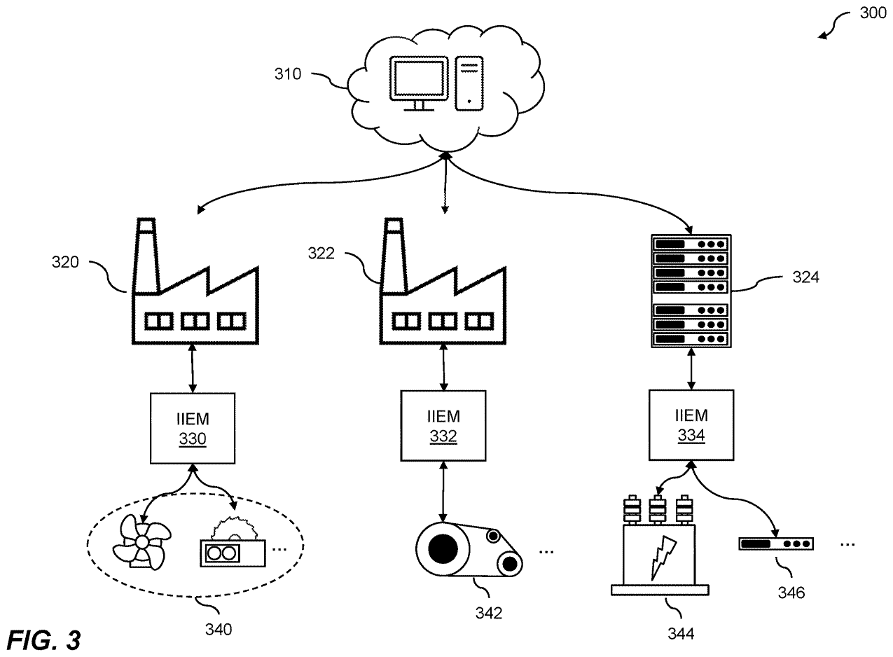

FIG. 3 is an infographic for IoT environments. An IoT environment can enable techniques for equipment monitoring. The Internet of Things (IoT) can refer to a network of interconnected devices that can exchange information over a network such as the Internet, a mobile network such as 5G or long-term evolution (LTE), a private network, short-range communication networks such as Bluetooth, and so on. The devices can include any function for which communication is desired. For example, IoT devices can be used in securing a home with devices such as security cameras, smart thermostats, smart door locks, kitchen appliances, smoke detectors, and so on. These devices can communicate with other devices, systems, networks, etc. to report status, an error, an alert, and so on. Software such as a web application or mobile application can accumulate data from IoT devices and show status, connectivity, battery power, live information, warnings, etc. associated with the devices. Many other applications of IoT devices are possible, such as fitness trackers, smart cars, smart lighting, smart appliances such as ovens and refrigerators, smart plugs and outlets, and so on. The Industrial IoT is an extension of IoT for industrial devices to monitor function, environment, behavior, etc. of machines within industrial environments such as data centers, manufacturing facilities, power plants, wastewater treatment facilities, and many others. The devices can comprise sensors, instruments, machines, etc. that can exchange real-time data about the conditions of one or more machines within the environment, report problems, take actions (such as shutting off a machine), and so on. Such devices can include temperature sensors, pressure sensors, vibration sensors, flow sensors, actuators, monitors, programmable logic controllers (PLCs), and many more.

As discussed above and throughout, an industrial IoT environment can enable techniques for autonomous identification of electrical signals. An industrial IoT electrical monitor (IIEM) is accessed. The IIEM can be coupled to one or more industrial devices within one or more environments. The IIEM can detect and record any operating condition of electrical equipment such as voltage, current, humidity, temperature, vibration, and so on. The IIEM can receive one or more uploading instructions from a cloud server. The one or more uploading instructions can detail how and when the IIEM should upload electrical data to a cloud server. The IIEM can use different instructions for each coupled piece of electrical equipment. Electrical data associated with one or more industrial devices is recorded by the IIEM. The IIEM can determine whether the electrical data that was recorded represents an anomalous event which is related to the one or more industrial devices. The determining can be based on the one or more uploading instructions. The IIEM can upload the electrical data to a cloud server, based on the determining. The IIEM can analyze, summarize, etc. the electrical data prior to the uploading.

The infographic 300 includes cloud server 310. In disclosed implementations, the cloud server 310 can be implemented as a bare metal server, one or more containerized instances, and/or one or more virtual machines. The cloud server can include a server in a cloud service such as Amazon Web Services (AWS), a custom managed server, a local server (e.g., on-site server, computer, and so on), etc. The cloud server can include any number of physical servers within a rack, data center, network, and so on. The cloud server can include any type of processor, ASIC, SoC, AI accelerator, etc. Load balancing and/or orchestration can be used to enable scaling of cloud server capabilities as the number of industrial devices being monitored increases. The cloud server can communicate with one or more IIEM devices located in various environments, such as facilities and/or locations which house equipment. The cloud server can communicate with the one or more IIEM devices via the Internet, cellular networks, satellite networks, and/or other suitable communication techniques. The IIEM can comprise an IoT node.

As shown in infographic 300, a first IIEM 330 is installed within a first environment 320, a second IIEM 332 is installed within a second environment 322, and a third IIEM 334 is installed within a third environment 324. The first and second environments are shown as manufacturing facilities, and the third environment is shown as a data center. In practice, any environment can be monitored by the IIEM. For example, the equipment can be located in a room within a food processing facility, a rack within a data center, a floor within a manufacturing facility, outdoors, and so on. Any number of IIEMs can be coupled to any number of industrial devices in any number of environments. In a usage example, a single IIEM can be coupled to a bandsaw and a table saw within a wood shop. In the infographic 300, IIEM 330 monitors two industrial devices 340, a fan and a table saw, within environment 320. IIEM 332 monitors a single belt drive 342 within environment 322. IIEM 334 monitors a generator 344 and computing equipment 346 within environment 324, a data center.

Environment 320, environment 322, and environment 324 can be located in different geographical regions, or similar regions. The industrial devices can include elevators, centrifuges, saws, drills, conveyor belts, CNC machines, 3D printers, welding machines, injection molding machines, robotic arms, packaging equipment, sorting machines, uninterruptible power supplies, generators, power transformers, industrial circuit breakers, power distribution units, industrial HVAC systems, furnaces, boilers, refrigeration units, dehumidifiers and humidifiers, pumps, compressors, mixing tanks, water treatment systems, data center computer servers, network switches, load balancers, uninterruptible power supplies, routers, and/or other types of industrial devices. The IIEMs shown in infographic 300 can capture data from the industrial equipment, and can analyze, summarize, and/or send the data to the cloud server. The IIEMs can be instrumental in recognizing and preventing industrial equipment failures.

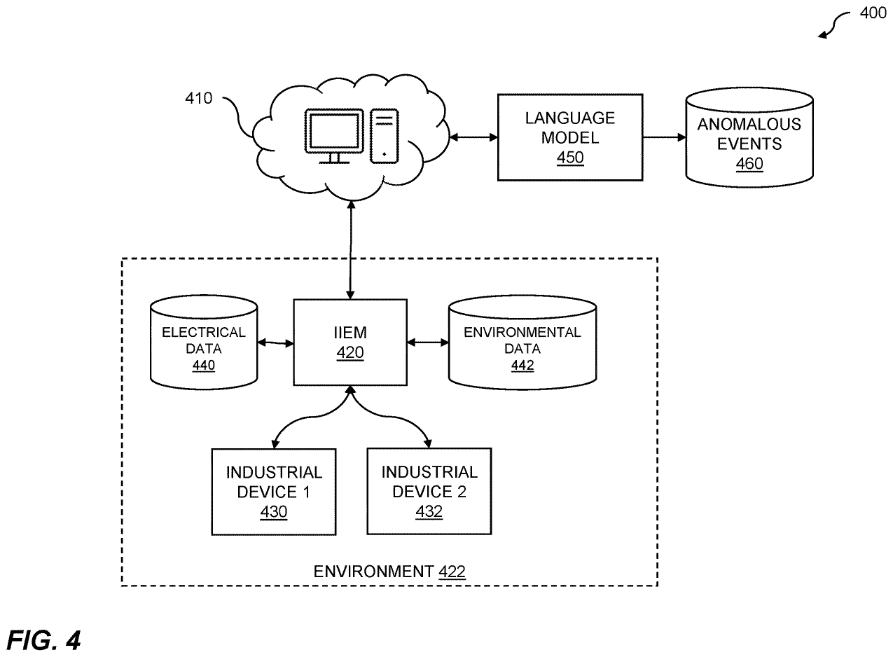

FIG. 4 is a block diagram for interpreting electrical data. The block diagram 400 includes a cloud server 410. Similar to cloud server 310 described previously, cloud server 410 can be implemented as a bare metal server, one or more containerized instances, and/or one or more virtual machines. The cloud server can include a server in a cloud service such as Amazon Web Services (AWS), a custom managed server, a local server (e.g., on-site server, computer, and so on), etc. The cloud server can include any number of physical servers within a rack, data center, network, and so on. The cloud server can include any type of processor, ASIC, SoC, AI accelerator, etc. Load balancing and/or orchestration can be used to enable scaling of cloud server capabilities as the number of industrial devices being monitored increases.

The cloud server 410 can communicate with one or more IIEM devices located at various facilities and/or locations. The cloud server can communicate with the one or more IIEM devices via the Internet, cellular networks, satellite networks, and/or other suitable communication techniques. The cloud server can send one or more sets of uploading instructions to the one or more IIEMs to instruct IIEMs on how often data should be reported, what types of data should be reported, or if local analysis should be performed; to scan for one or more situations of interest; etc. As shown in block diagram 400, the cloud server is configured to communicate with an IIEM 420 within an environment 422. While one environment is shown in block diagram 400, in practice, there can be more than one environment. Different environments can represent different facilities, different sections within the same facility, and so on. There can be more than one IIEM per environment.

As shown in the block diagram 400, IIEM 420 is configured to monitor industrial device 1 430, and industrial device 2 432. Any number of industrial devices can be associated with an IIEM. The IIEM can receive any number of uploading instructions from the cloud server. Each industrial device can be associated with a different uploading instruction, or uploading instructions can be shared between one or more industrial devices coupled to the IIEM. A first uploading instruction within one or more uploading instructions can be associated with a first industrial device within the one or more industrial devices, and a second uploading instruction within the one or more uploading instructions can be associated with a second industrial device within the one or more industrial devices. The uploading instructions can specify an uploading frequency. An uploading frequency of the first uploading instruction can be different from an uploading frequency of the second uploading instruction. In disclosed implementations, the industrial devices may send data directly to the IIEM 420.

Embodiments include recording, by the IIEM, electrical data 440 associated with the one or more industrial devices, wherein the recording is based on a sampling frequency. The data that is collected can include electrical data, environmental data, etc. The electrical data can include voltage, current, transient waveforms, and so on. The environmental data 442 can include data such as airflow, temperature, humidity, and so on. In embodiments, the recording includes environmental data, wherein the one or more signatures include the environmental data. In embodiments, the environmental data includes temperature data, vibration data, humidity data, airflow volume data, and/or airflow volume data. The collected data can be sent to the cloud server according to one or more uploading instructions.

In embodiments, the one or more uploading instructions include an uploading frequency, wherein the uploading is based on the uploading frequency. The uploading instructions can define one or more situations of interest (not shown in the block diagram 400), as previously described. When the IIEM detects that the collected data corresponds to a defined situation of interest, the IIEM can send data to the cloud server, regardless of the uploading frequency. The cloud server can send a new set of uploading instructions at any time to any IIEM. The new uploading instructions can cause the IIEM to send data more or less frequently, define additional or different anomalous events, remove one or more anomalous events, direct the IIEM to perform local analysis, and so on.

The cloud server 410 can send the electrical data that was uploaded to a language model 450. The language model can be a type of machine learning model that can be trained to understand, generate, and predict tokenized events, including human language. In disclosed implementations the language model is trained on a wide variety of data, ranging from books and websites to technical manuals and sensor logs, and so on. The language model can use the previously described contextual information to aid inferences. In some examples, the language model can be trained with the contextual information. For example, if the model detects a condition that “a motor is drawing more current than usual,” it can learn that the condition is often associated with a potential problem in an industrial setting. The language model can identify one or more anomalous events 460. As described above and throughout, an anomalous event can refer to a failure, a difference from normal operation, and so on in a piece of equipment. Anomalous events can be reported to a user, a floor manager, maintenance personnel, etc. to investigate whether a part failed or experienced a partial failure, to protect against a future failure, to investigate a non-normal operation, etc. The anomalous event can be associated with a signature within the operational data that was collected by the IIEM, a situation of interest, etc. The electrical signature can be correlated to an anomalous event by the LLM and applied to one or more pieces of equipment. Examples of anomalous events can include motor aging, increased mechanical resistance, equipment overheating, loss of efficiency, different material being mixed within a mixer, an unplanned equipment shutdown, improper grounding issues, a broken drive belt on a motor, a worn-out bearing in a fan or pump, a motor speed controller failure, coil degradation and/or insulation breakdown, loose wiring and/or failing relays, and the like.

The language models used in disclosed implementations can assign probabilities to sequences of words (or tokens). In disclosed implementations, the language model can be based on neural networks that can include transformers and/or attention mechanisms to weigh the importance of different parts of a sentence and/or dataset. This can enable the handling of complex tasks like summarizing industrial device information, classifying environmental data, and/or predicting potential failure events. As an example, the language model can recognize an abnormal electrical signal pattern, correlate it with historical data, and generate output such as “Likely cause: motor belt failure,” thereby turning raw data into actionable insights that can increase operational efficiency. In disclosed implementations, the identifying component can include a user interface, such as a dashboard, which can display the status of one or more industrial devices.

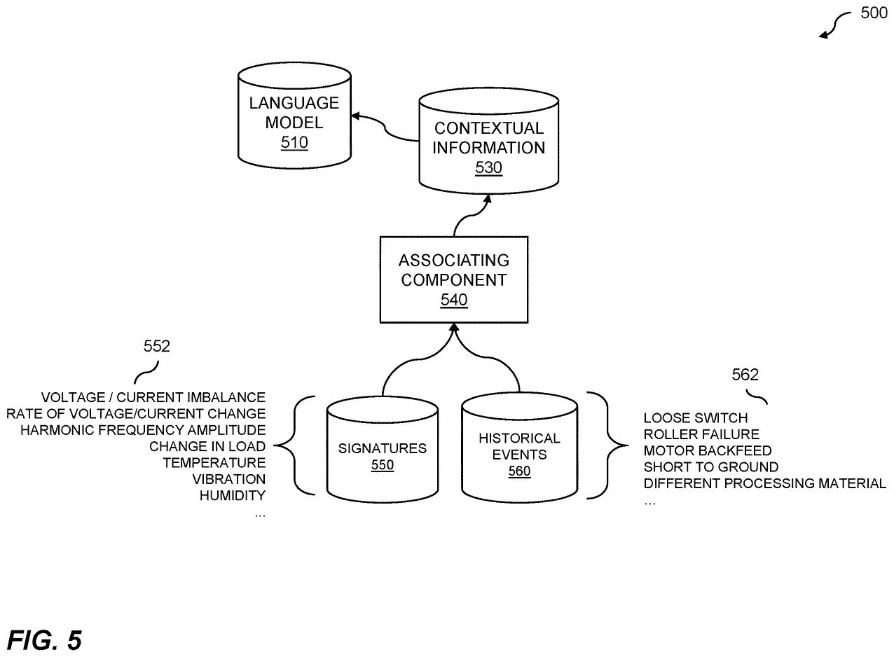

FIG. 5 is a block diagram for developing contextual information. The block diagram 500 can include a database of signatures 550. The signatures can include readings and/or trends for one or more parameters 552. The parameters 552 can include, but are not limited to, electrical parameters such as a voltage imbalance, current imbalance, rate of voltage change, rate of current change, harmonic frequency amplitude, and/or change in power load. The parameters 552 can include, but are not limited to, environmental parameters such as temperature, vibration, and/or humidity. The block diagram 500 further includes a database of historical events 560. The historical events 560 can include one or more failure modes 562. The failure modes 562 can include, but are not limited to, a loose switch, a roller failure, motor back feed, a short to ground, a different processing material, and so on.

The signatures 550 and historical events 560 are input to an associating component 540. The associating component 540 can create data that associates a signature with a given historical event. In disclosed implementations, the associating component 540 can create data in a comma separated value (CSV) format, a JSON format (such as described previously), an XML format, a YAML format, and/or other suitable data format. The associated data serves as contextual information 530 that can be input to language model 510 for training, validation, and/or inference.

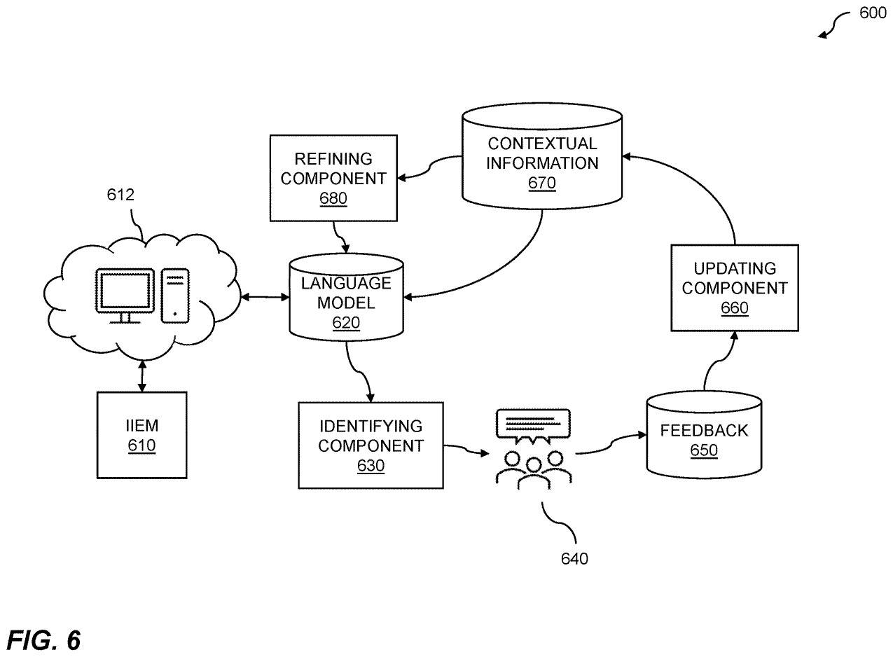

FIG. 6 is a block diagram for refining a language model based on updated contextual information. The block diagram 600 includes an IIEM 610. In disclosed implementations, the IIEM may be configured to obtain electrical data and/or environmental data from one or more industrial devices, such as depicted in FIG. 3 and FIG. 4. The data from the IIEM is sent to a cloud server 612. Cloud server may be similar to the cloud server 310 described previously. The data from the cloud server is input to language model 620. The language model 620 may be a large language model, small language model, or other suitable type of language model. In embodiments, the language model is executed by the cloud server. In disclosed implementations, a large language model may have hundreds of billions of parameters and is well suited for hosting on one or more cloud servers. A small language model may have fewer parameters and can also run on one or more servers. A SLM can be small enough for operation on an edge device. One or more implementations may utilize knowledge distillation techniques to train a small language model from a large language model. Thus, in disclosed implementations, a large language model can serve as a teacher model for a small language model that can be more easily trained, refined, and so on. The SLM can also operate on an edge device, such as an IIEM or other locally-hosted computing device within an environment. As a non-limiting example, the teacher model can learn to recognize subtle signal changes, such as the precise current drop pattern that can indicate a broken belt, by analyzing historical data from many motors under various conditions. The distilled small language model can be deployed on an edge device near the equipment, such as an IIEM, continuously monitoring electrical signals in real time. If the IIEM detects an anomalous event, such as a spike suggesting increased viscosity in a mixer, it could immediately flag the issue or trigger an automated response, including automatic shutdown of equipment (such as the mixer, and/or a conveyor system feeding material into the mixer). This use of a small language model can reduce the need for constant cloud connectivity, minimize latency, and enable quicker responses while keeping hardware costs down.

The output of language model 620 can be input to an identifying component 630. The identifying component can identify, by a language model, one or more anomalous events associated with an industrial device within the one or more industrial devices, wherein the identifying is based on the electrical data that was recorded, and wherein the identifying is further based on contextual information. The output of the identifying component can be presented to stakeholders 640, such as employees, shop managers, engineers, maintenance technicians, and so on. The stakeholders can verify the anomalous events identified by the LLM. Embodiments include verifying the one or more anomalous events that were identified. The verifying can be received from the stakeholders as feedback 650. The feedback can include confirmation and/or correction of the output of the language model. The feedback can be input to an updating component 660. Embodiments include updating the contextual information, wherein the updating is based on the verifying. The updating component can update data to indicate that a prediction from the language model 620 was correct or incorrect. The output of the updating component includes contextual information 670, which can be input back to the language model to expand the scope of input data that the language model 620 is exposed to.

The contextual information can also be input to a refining component 680. The refining component can make adjustments to the language model 620, such as adjusting weights, adjusting biases, adding connections, removing connections, adding layers, removing layers, and/or making other modifications to the language model to refine and/or fine-tune the output of the language model based on new information from industrial devices. Thus, in disclosed implementations, contextual information gathered from industrial devices is fed back into a language model to continuously improve its performance. The updating component 660 feeds contextual data back into the model, broadening the range of input data the language model learns from. The refining component can adjust the model's internal structure (e.g., weights, biases, connections, and layers) to fine-tune its outputs based on the new data. The language model 620 therefore can evolve over time, becoming more precise in recognizing equipment issues and predicting failures. Additionally, by refining its understanding of “normal” vs. “anomalous” behavior, the language model can reduce unnecessary alerts (false positives). Thus, disclosed implementations can learn not only from the initial training data but also from ongoing operations, thereby enabling a major advantage in dynamic industrial environments.

In embodiments, the language model comprises a large language model (LLM). Some embodiments include refining the LLM, wherein the refining is based on the contextual information that was updated. In embodiments, the refining is based on parameter-efficient tuning. In other embodiments, the refining is based on retrieval-augmented generation (RAG). In some embodiments, the language model comprises a small language model (SLM). Embodiments include training the SLM, wherein the training is based on the contextual information that was updated.

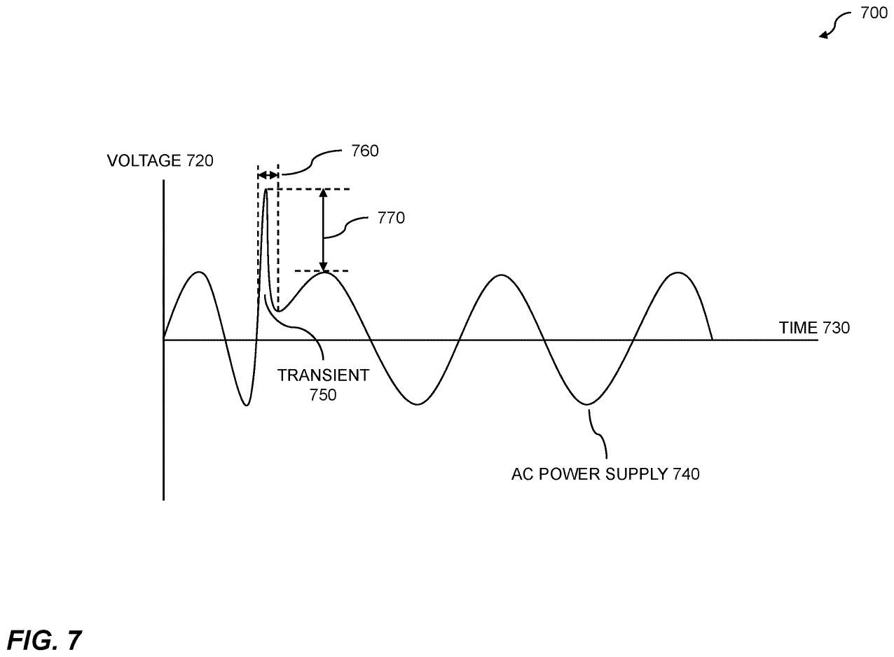

FIG. 7 is an example of a voltage transient. The example 700 includes a horizontal axis 730 representing time, and a vertical axis 720 representing voltage magnitude. Signal 740 represents a monitored alternating current voltage. A transient 750 has a peak amplitude above the normal maximum, indicated at 770, and a peak duration, indicated at 760. In disclosed implementations, if a transient exceeds a predetermined peak duration and/or peak amplitude above the normal maximum, then the transient can be treated as an anomalous event. The predetermined peak and/or duration can be defined heuristically from previous failures on similar equipment, via machine learning on a historical database, manually by a human, and so on. The cloud server can send updated uploading instructions to any IIEM with updated predetermined thresholds such as duration and peak magnitude. Thus, the cloud server can dynamically change the definition of an anomalous event. A similar principle can be applied to electrical current as well as voltage. The number of transients detected within a given time duration can be an anomalous event. Too many transients within a given time duration can be indicative of power grid instability, and/or other adverse conditions. The uploading instruction can include a threshold rate of transients, such as voltage or current transients.

Voltage spikes, current spikes, and/or other transient events on an AC power line can occur when there is a sudden, short-duration increase in voltage or current. These transients can often last from nanoseconds to milliseconds and can cause significant disruptions or damage to electrical systems. There are various contributors to transient events. Direct lightning strikes to power lines can cause massive voltage surges. Even indirect lightning strikes can induce electromagnetic pulses that can travel through power lines and damage equipment. Switching operations in the power grid can also cause transient events. For example, the energization or de-energization of long power lines can cause transient voltages due to the capacitance and inductance of the power grid. Moreover, the starting or stopping of industrial equipment such as motors, compressors, furnaces, and large transformers can cause sudden current draws or dumps, leading to voltage sags, spikes, harmonic distortions, etc. Short circuits and faults can cause sudden shifts in current, which can result in transients. Additionally, if a large facility or region suddenly disconnects from the power grid, the abrupt loss of load can create transient voltage fluctuations. Nonlinear loads (such as rectifiers, variable frequency drives, and power electronics) can introduce harmonics into the power grid. Furthermore, high-power RF sources, such as nearby radio transmitters or industrial RF equipment, can couple energy into power lines, introducing high-frequency transients. Regardless of the cause, these transients can damage sensitive electronics, reduce the lifespan of equipment, and cause operational disruptions. The real-time monitoring of disclosed implementations can help mitigate the impact of transients. In embodiments, the anomalous event comprises a peak magnitude of the transient waveform, wherein an absolute value of the peak magnitude exceeds a transient magnitude threshold. In embodiments, the anomalous event comprises a length of the transient waveform, wherein the length exceeds a transient length threshold. In disclosed implementations, the transient magnitude threshold and/or transient length threshold can be user-defined, and/or initialized to default values that can be adjusted later based on performance of the monitored industrial devices.

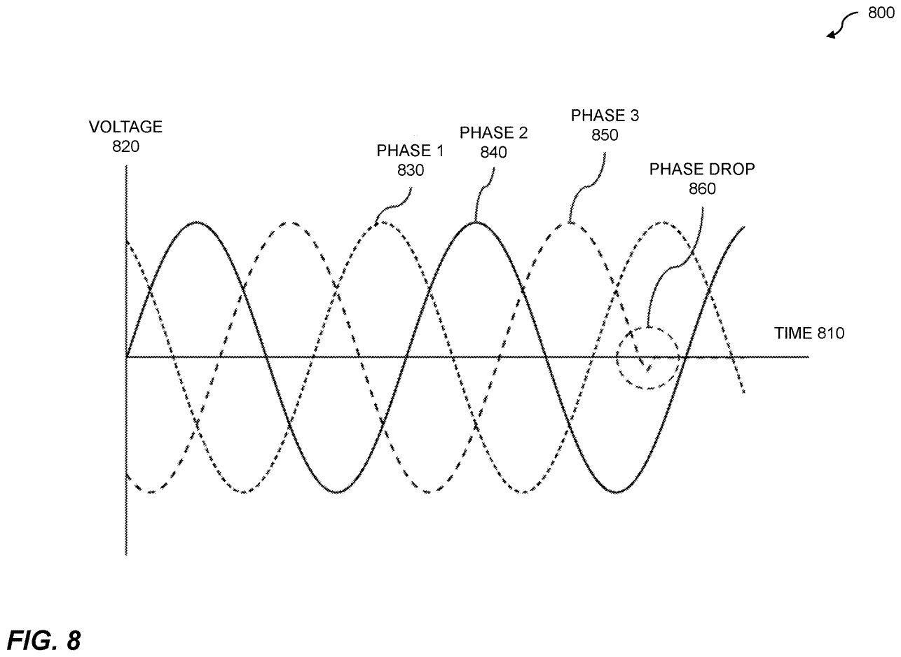

FIG. 8 is an example of a phase drop. The example 800 includes a horizontal axis 810 representing time, and a vertical axis 820 representing voltage magnitude. A first phase 830, second phase 840, and third phase 850 are shown. Three-phase power is a type of AC (alternating current) electrical power distribution that includes three sinusoidal voltage waveforms that are evenly spaced in phase. Three-phase power is the most common technique used for transmitting and distributing electrical power in industrial, commercial, and high-power applications, because it provides a more balanced and efficient power delivery compared to single-phase systems. In a balanced three-phase system, each voltage waveform has the same frequency and amplitude (e.g., peak voltage). Each phase is 120 degrees out of phase with the other phases. The frequency can typically range from 50 Hertz to 60 Hertz. In disclosed implementations, the three-phase power can be in a wye configuration or a delta configuration. Note that the vertical axis can be a current axis instead, without departing from the disclosed concepts.

A phase drop 860 that is associated with phase 3 is shown in example 800. A phase drop (also known as single-phase loss) in a three-phase power system occurs when one of the three voltage phases fails or experiences a significant drop while the other two remain active. This can result from various issues, including a blown fuse, a tripped breaker, loose or damaged wiring, transformer failure, or unbalanced loads that lead to excessive current draw in a single phase. In embodiments, the one or more industrial devices are powered by three-phase power. Many industrial machines, such as motors, compressors, pumps, CNC machines, robotic arms, and HVAC systems, rely on a stable and balanced three-phase power supply for optimal performance. A phase drop can lead to severe consequences, including overheating, motor damage, torque loss, and overall performance degradation.

Recall that an IIEM can determine whether the electrical data that was recorded represents an anomalous event related to the one or more industrial devices, wherein the determining is based on the one or more uploading instructions. In some embodiments, the determining includes detecting a phase drop, wherein the anomalous event comprises the phase drop. Industrial devices can be automatically shut down upon detecting a phase drop in their power supply to prevent potential damage. In the described implementations, a phase drop can be designated as an anomalous event, causing one or more IIEMs to send electrical data to the cloud server. In response, the cloud server and/or the IIEM can warn a user, send an alert, shut down the equipment, and so on.

The detection of a phase drop can include performing a phase-to-neutral voltage check. The detection of a phase drop can include measuring the voltage of each phase relative to neutral (if available). A significant drop or loss in one phase indicates a phase drop. The detection of a phase drop can include performing a phase-to-phase voltage check. This can include comparing voltages between phases. A missing or significantly lower voltage between two phases can signal a phase failure. Some implementations can utilize phase angle monitoring to detect a phase drop. One or more implementations may utilize a phase loss relay to detect missing phases and trigger alerts and/or shutdowns of industrial equipment.

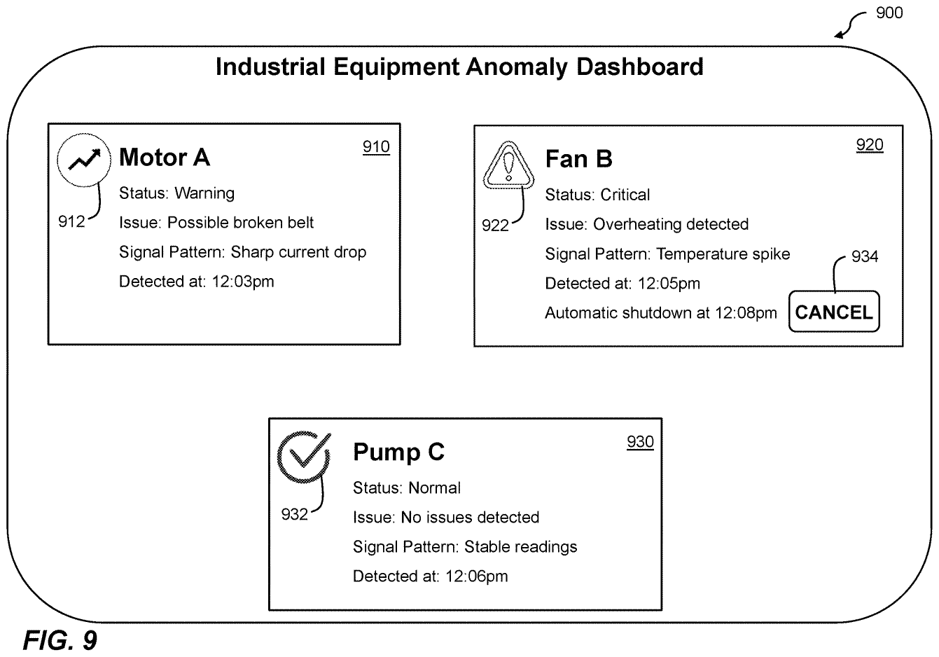

FIG. 9 is an example of an industrial equipment anomaly dashboard for autonomous identification of electrical signatures with IoT-enabled monitors. The dashboard 900 can be rendered and presented on an electronic display of a computing device such as a smartphone, tablet computer, laptop computer, wearable computer, and so on. In the example shown in FIG. 9, the status for three industrial devices is shown, indicated at 910, 920, and 930. For each device, a status icon can be used to quickly ascertain if there is a potential problem. As an example, the icon 932 for the industrial device indicated at 930 is a checkmark that indicates normal operation. The icon 912 for the industrial device indicated at 910 is an upward trend that indicates a warning condition and a potential problem. The icon 922 for the industrial device indicated at 920 is an error icon that indicates an error condition and a likely problem. In disclosed implementations, one or more industrial devices may be automatically shut down in response to detecting an error condition. In some implementations, a delayed shutdown feature may be included, to enable an operator to have an opportunity to cancel the shutdown and take manual control. As shown in the example, for the industrial device indicated at 920, there is a cancel button 934 that, when invoked by a user, causes the system to cancel an upcoming automatic shutdown. In this way, disclosed implementations can reduce damage to industrial equipment and improve safety by reducing the possibility of equipment operating in unsafe situations.

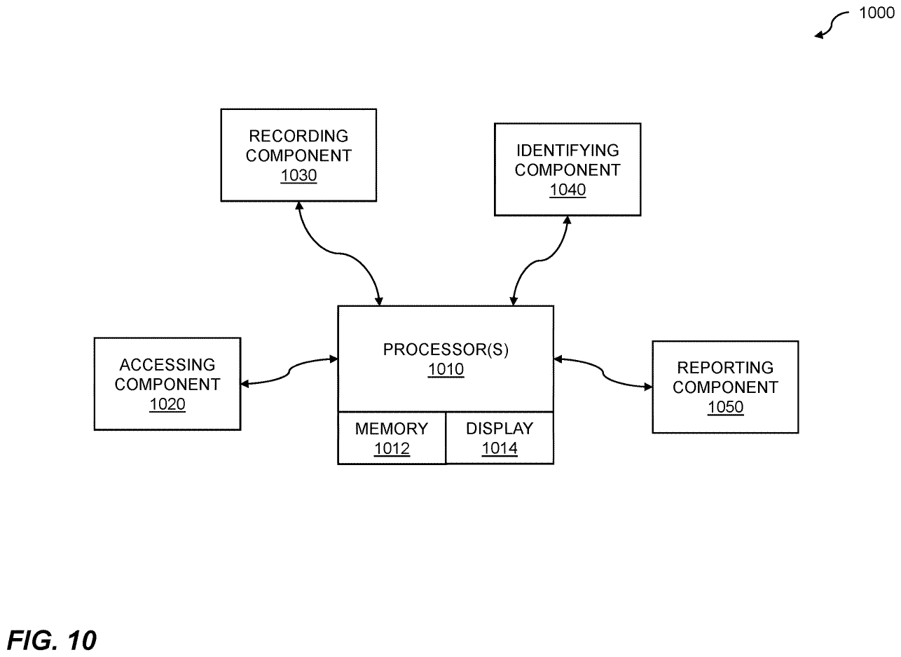

FIG. 10 is a system diagram for autonomous interpretation of electrical signatures with IoT-enabled monitors. The system 1000 can comprise a computer system for implementation of autonomous identification of electrical signatures with IoT-enabled monitors. The computer system can be based on semiconductor logic. The system can include one or more of processors, memories, cache memories, queues, displays, communication channels and networks, and so on. The system 1000 can include one or more processors 1010. The processors can include standalone processors within integrated circuits or chips, processor cores in FPGAs or ASICs, two or more processor cores within a multiprocessor, and the like. The one or more processors 1010 are coupled to a memory 1012, which can store instructions, operations, network traffic data, data requests, electrical data analysis, heuristics for industrial environments, routing information, language model training information, inference information from a language model, and so on. The memory can include one or more of local memory, shared cache memory, shared hierarchical cache memory, system memory such as shared system memory, etc. The system 1000 can further include a display 1014 coupled to the one or more processors. The display can be used for displaying data, instructions, operations, industrial equipment monitoring dashboards, etc. The operations can include routing operations, data transfer operations, and so on.

The system 1000 can include an accessing component 1020. The accessing component 1020 can include functions and instructions for accessing an industrial IoT electrical monitor (IIEM), wherein the IIEM is coupled to one or more industrial devices within one or more environments. As previously described, the IIEM can record data from one or more industrial devices and send the data to a cloud server. The recording can be based on a sampling frequency, one or more anomalous events, etc. The sending can be based on the uploading instructions. The cloud server can update the uploading instructions at any time. The accessing can include using one or more application programming interface (API) calls. The accessing can include use of RESTful APIs (HTTP/HTTPS), MQTT (Message Queuing Telemetry Transport), CoAP (Constrained Application Protocol), AMQP (Advanced Message Queuing Protocol), OPC UA (Open Platform Communications Unified Architecture), WebSockets (for Real-Time Monitoring via Web Applications), LoRaWAN (for Remote, Low-Power Monitoring), and/or other suitable protocols.

The system 1000 can include a recording component 1030. The recording component 1030 can include functions and instructions for recording, by the IIEM, electrical data associated with the one or more industrial devices, wherein the recording is based on a sampling frequency. The electrical data can include voltage data, current data, frequency data, phase data, data regarding transients, three-phase data, DC ripple data, and/or other relevant electrical data. The electrical data can be analyzed before it is sent to the cloud server. The analysis can be based on an FFT, STFT, wavelet transform, and so on. The sampling frequency can comprise 20 kHz, 40 kHz, 100 kHz, or any other suitable frequency. The electrical data can be uploaded to a cloud server. Embodiments include uploading, by the IIEM, to a cloud server, the electrical data that was recorded, wherein the uploading is based on one or more uploading instructions. The uploading instructions can specify an uploading frequency, such as ten times per minute, or any other frequency. The uploading instructions can specify a situation of interest, such as a phase drop, a sudden temperature rise above a threshold, or another electrical or environmental condition. The uploading instructions can cause the IIEM to send data to the cloud server regardless of the uploading frequency.

The system 1000 can include an identifying component 1040. The identifying component 1040 can include functions and instructions for identifying, by a language model, one or more anomalous events associated with an industrial device within the one or more industrial devices, wherein the identifying is based on the electrical data that was recorded, and wherein the identifying is further based on contextual information. The identifying can utilize a language model. The language model can include a large language model, small language model, and/or other type of language model. In disclosed implementations, trained machine learning models can be used to identify patterns corresponding to an anomalous event.

The system 1000 can include a reporting component 1050. The reporting component 1050 can include functions and instructions for reporting, to a user, the one or more anomalous events that were identified, wherein the one or more anomalous events are based on the electrical data that was recorded. The reporting may be performed via a dashboard, such as depicted in FIG. 9. The reporting schedule can be dynamic. The frequency of the reporting can change in response to identifying an anomalous event. The data that is uploaded can include data occurring both before and after an anomalous event is determined. As an example, in response to determining an anomalous event, 20 seconds of data prior to the anomalous event, along with 20 seconds of data following the anomalous event, can be uploaded to a cloud server for subsequent analysis. In embodiments, the uploading includes one or more portions of the electrical data surrounding the anomalous event. In disclosed implementations, only a portion of the data collected by an IIEM is uploaded, while another portion of the data collected by an IIEM may be temporarily stored locally and then discarded. In embodiments, the uploading of instructions and/or reporting schedule can be based on a previous failure history of the one or more industrial devices. For example, industrial devices that have a history of frequent failure may be monitored and/or reported with a higher uploading frequency than industrial devices that do not have a history of frequent failure.

The system 1000 can include a computer program product embodied in a non-transitory computer readable medium for analysis, the computer program product comprising code which causes one or more processors to perform operations of: accessing an industrial IoT electrical monitor (IIEM), wherein the IIEM is coupled to one or more industrial devices within one or more environments; recording, by the IIEM, electrical data associated with the one or more industrial devices, wherein the recording is based on a sampling frequency; identifying, by a language model, one or more anomalous events associated with an industrial device within the one or more industrial devices, wherein the identifying is based on the electrical data that was recorded, and wherein the identifying is further based on contextual information; and reporting, to a user, the one or more anomalous events that were identified, wherein the one or more anomalous events are based on the electrical data that was recorded.

The system 1000 can include a computer system for analysis comprising: a memory which stores instructions; one or more processors attached to the memory, wherein the one or more processors, when executing the instructions which are stored, are configured to: access an industrial IoT electrical monitor (IIEM), wherein the IIEM is coupled to one or more industrial devices within one or more environments; record, by the IIEM, electrical data associated with the one or more industrial devices, wherein the recording is based on a sampling frequency; identify, by a language model, one or more anomalous events associated with an industrial device within the one or more industrial devices, wherein the identifying is based on the electrical data that was recorded, and wherein the identifying is further based on contextual information; and report, to a user, the one or more anomalous events that were identified, wherein the one or more anomalous events are based on the electrical data that was recorded.

As can now be appreciated, disclosed implementations can leverage trained language models, which can include a large language model (LLM) hosted in the cloud, and/or a small language model (SLM) running locally on an edge device, to provide significant benefits for industrial environments, by identifying electrical and/or environmental data patterns linked to presently occurring or imminent equipment malfunctions. By detecting anomalies such as surges in current, voltage irregularities, and/or overheating, the system can issue timely alerts to operators and, when necessary, automatically slow down and/or shut down equipment to prevent further damage. This proactive approach can reduce unplanned downtime, ensuring that machinery stays operational for longer periods and improving overall productivity by minimizing interruptions. Operating costs can be lowered as well, since early intervention can help prevent catastrophic failures that require expensive repairs or equipment replacements. Additionally, worker safety can be significantly enhanced by reducing the likelihood of dangerous mechanical breakdowns, electrical fires, or exposure to harmful conditions. By combining real-time monitoring with intelligent, adaptive analysis, disclosed implementations can enable a safer, more reliable, and cost-efficient industrial environment.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A method for analysis comprising:
accessing an industrial IoT electrical monitor (IIEM), wherein the IIEM is coupled to one or more industrial devices within one or more environments;
recording, by the IIEM, electrical data associated with the one or more industrial devices, wherein the recording is based on a sampling frequency;
identifying, by a language model, one or more anomalous events associated with an industrial device within the one or more industrial devices, wherein the identifying is based on the electrical data that was recorded, and wherein the identifying is further based on contextual information; and
reporting, to a user, the one or more anomalous events that were identified, wherein the one or more anomalous events are based on the electrical data that was recorded.

2. The method of claim 1 wherein the contextual information includes a plurality of historical events.

3. The method of claim 2 further comprising associating each historical event within the plurality of historical events with one or more signatures.

4. The method of claim 3 wherein the one or more signatures include a current imbalance.

5. The method of claim 3 wherein the one or more signatures include a voltage imbalance.

6. The method of claim 3 wherein the one or more signatures include a rate of current change.

7. The method of claim 3 wherein the one or more signatures include a rate of voltage change.

8. The method of claim 3 wherein the one or more signatures include a harmonic frequency amplitude.

9. The method of claim 3 wherein the recording includes environmental data, wherein the one or more signatures include the environmental data.

10. The method of claim 9 wherein the environmental data includes vibration data.

11. The method of claim 1 wherein the identifying includes predicting, by the language model, a future failure of the one or more industrial devices.

12. The method of claim 1 further comprising verifying the one or more anomalous events that were identified.

13. The method of claim 12 further comprising updating the contextual information, wherein the updating is based on the verifying.

14. The method of claim 13 wherein the language model comprises a large language model (LLM).

15. The method of claim 14 further comprising refining the LLM, wherein the refining is based on the contextual information that was updated.

16. The method of claim 15 wherein the refining is based on parameter-efficient tuning.

17. The method of claim 15 wherein the refining is based on retrieval-augmented generation (RAG).

18. The method of claim 13 wherein the language model comprises a small language model (SLM).

19. The method of claim 18 further comprising training the SLM, wherein the training is based on the contextual information that was updated.

20. The method of claim 1 further comprising training the language model, wherein the training is based on the contextual information.

21. The method of claim 1 further comprising uploading, by the IIEM, to a cloud server, the electrical data that was recorded, wherein the uploading is based on one or more uploading instructions.

22. The method of claim 1 wherein the recording includes capturing a waveform of the electrical data associated with the one or more industrial devices.

23. The method of claim 22 wherein the identifying is based on performing local analysis, by the IIEM, on the electrical data that was recorded, wherein the local analysis includes a Fast Fourier transform (FFT).

24. A computer program product embodied in a non-transitory computer readable medium for analysis, the computer program product comprising code which causes one or more processors to perform operations of:
accessing an industrial IoT electrical monitor (IIEM), wherein the IIEM is coupled to one or more industrial devices within one or more environments;
recording, by the IIEM, electrical data associated with the one or more industrial devices, wherein the recording is based on a sampling frequency;
identifying, by a language model, one or more anomalous events associated with an industrial device within the one or more industrial devices, wherein the identifying is based on the electrical data that was recorded, and wherein the identifying is further based on contextual information; and
reporting, to a user, the one or more anomalous events that were identified, wherein the one or more anomalous events are based on the electrical data that was recorded.

25. A computer system for analysis comprising:
a memory which stores instructions;
one or more processors attached to the memory, wherein the one or more processors, when executing the instructions which are stored, are configured to:
access an industrial IoT electrical monitor (IIEM), wherein the IIEM is coupled to one or more industrial devices within one or more environments;
record, by the IIEM, electrical data associated with the one or more industrial devices, wherein the recording is based on a sampling frequency;
identify, by a language model, one or more anomalous events associated with an industrial device within the one or more industrial devices, wherein the identifying is based on the electrical data that was recorded, and wherein the identifying is further based on contextual information; and
report, to a user, the one or more anomalous events that were identified, wherein the one or more anomalous events are based on the electrical data that was recorded.
